(19) United States
(12) Patent Application Publication
(10) Pub. No.: US 2022/0399550 A1
(43) Pub. Date: Dec. 15, 2022

(54) SEPARATOR, FUEL CELL, AND METHOD FOR MANUFACTURING SEPARATOR

(71) Applicant: Robert Bosch GmbH, Stuttgart (DE)

(72) Inventors: Tong Bu, Tokyo (JP); Shigetaka Uehara, Tokyo (JP); Shogo Takamuku, Tokyo (JP)

(21) Appl. No.: 17/778,432

(22) PCT Filed: Nov. 12, 2020
(86) PCT No.: PCT/IB2020/060656

§ 371 Date: May 20, 2022

(30) Foreign Application Priority Data
Nov. 20, 2019 (JP) 2019-209818
Jun. 10, 2020 (JP) 2020-101107

(51) Int. Cl. H01M 8/0226; H01M 8/0206; H01M 8/0228; H01M 8/0254

(52) U.S. Cl. CPC H01M 8/0226; H01M 8/0206; H01M 8/0228; H01M 8/0254

(57) ABSTRACT

[Problem] To provide a separator excellent in corrosion resistance and a sealing property for a fuel gas.

[Means for Resolution] Provided is a separator (4) for fuel cells. The separator (4) includes a conductive substrate (41), and a protective layer (42) that covers at least a part of a surface of the substrate (41). The protective layer (42) contains a self-restoring material.

### BACKGROUND OF THE INVENTION

The present invention relates to a separator, a fuel cell, and a method for manufacturing a separator.

Typically, a solid polymer type fuel cell includes a membrane electrode assembly that generates power by causing a fuel gas to chemically react, and a pair of separators which are respectively disposed on both sides of the membrane electrode assembly. A concave portion that forms a flow path of a fuel gas is formed to a surface of each of the separators which are in contact with the membrane electrode assembly by press processing or the like.

Under a usage environment of the fuel cell, an oxide film due to corrosion may be formed on the surface of the separator formed from a metal. The oxide film is likely to increase contact resistance with an electrode and to deteriorate current collection performance of the separator. Therefore, there is suggested a configuration in which the surface of the separator is covered with a resin layer including conductive filler to increase corrosion resistance of the separator (for example, refer to Japanese Patent No. 4458877).

When processing forming such as cutting processing and press processing is performed after the resin layer is formed, defects such as pin holes, voids, and cracks are likely to occur inside the resin layer. To restore the defects of the resin layer, a heating treatment of melting a resin in the resin layer is necessary as in Japanese Patent No. 4458877, and thus manufacturing cost increases.

On the other hand, when forming the resin layer after processing forming, defects due to the processing forming do not occur. However, even though defects are restored or occurrence of the defects can be avoided at the time of manufacturing, the resin layer itself is soft, and thus there is a possibility that defects such as cracks may occur and corrosion may occur after manufacturing. In addition, defects may occur in a substrate itself, and in this case, a fuel gas may leak to the outside from a defective portion of the substrate and the resin layer.

Even in a carbon separator instead of the metal separator, defects may occur at the time of manufacturing or after manufacturing.

### SUMMARY OF THE INVENTION

An object of the invention is to provide a separator excellent in corrosion resistance and a sealing property for a fuel gas.

According to an aspect of the invention, there is provided a separator (4) for fuel cells. The separator (4) includes: a conductive substrate (41); and a protective layer (42) that covers at least a part of a surface of the substrate (41). The protective layer (42) contains a self-restoring material.

According to another aspect of the invention, there is provided a conductive separator (4C) for fuel cells. The conductive separator (4C) contains a self-restoring material at the inside.

According to still another aspect of the invention, there is provided a fuel cell (100) including a plurality of membrane electrode assemblies (3). The fuel cell (100) includes a pair of separators (4) which are respectively disposed on both sides of each of the membrane electrode assemblies (3) and in which a concave portion (4a) is provided to a surface on the membrane electrode assembly (3) side. The separators (4) include a conductive substrate (41), and a protective layer (42) that is provided to at least a part of a surface of the substrate (41), and the protective layer (42) contains a self-restoring material.

According to still another aspect of the invention, there is provided a fuel cell (100) including a plurality of membrane electrode assemblies (3). The fuel cell (100) includes a pair of separators (4C) which are respectively disposed on both sides of each of the membrane electrode assemblies (3) and in which a concave portion (4a) is provided to a surface on the membrane electrode assembly (3) side. The separators (4C) contain a self-restoring material at the inside.

According to still another aspect of the invention, there is provided a method for manufacturing a separator (4) for fuel cells, the separator (4) including a conductive substrate (41) and a protective layer (42) that is provided to at least a part of a surface of the substrate (41). The method includes: a step of forming the protective layer (42) on at least a part of the surface of the substrate (41); and a step of performing forming processing on the substrate (41) on which the protective layer (42) is formed. The protective layer (42) contains a self-restoring material.

According to the invention, it is possible to provide a separator excellent in corrosion resistance and a sealing property for a fuel gas.

### BRIEF DESCRIPTION OF THE DRAWINGS

FIG. 1 is a cross-sectional view illustrating a configuration of a fuel cell according to a first embodiment.

FIG. 2 is a cross-sectional view illustrating a configuration of a cell.

FIG. 3 is an enlarged cross-sectional view illustrating a configuration of a separator according to the first embodiment.

FIG. 4 is a view schematically illustrating a process of manufacturing the separator.

FIG. 5 is a cross-sectional view illustrating a configuration of a cell according to a second embodiment.

FIG. 6 is a side view illustrating a process of manufacturing a carbon separator.

FIG. 7 is a side view illustrating the process of manufacturing the carbon separator.

FIG. 8 is an enlarged view of a concave portion of the carbon separator.

### DETAILED DESCRIPTION

Hereinafter, embodiments of a separator, a fuel cell, and a method for manufacturing the separator according to the invention will be described with reference to the accompanying drawings. The following configuration is an example (representative example) of the invention, and there is no limitation to the example.

### First Embodiment

### (Fuel Cell)

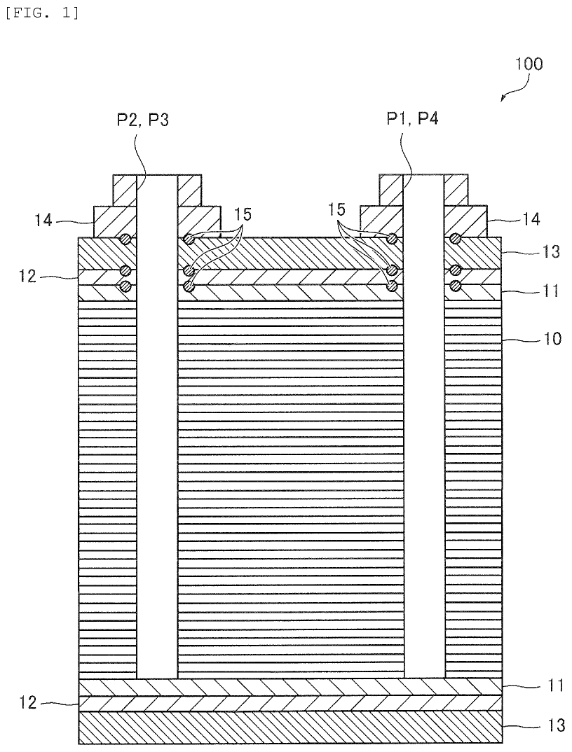

FIG. 1 illustrates a configuration of a fuel cell 100 of this embodiment.

The fuel cell of this embodiment is mounted, for example, to a mobile body such as a vehicle, generates power by subjecting a fuel gas to a chemical reaction, and supplies drive power to the mobile body, but the invention is applicable to a fuel cell of a stationary power generation system without limitation to the mobile body.

As illustrated in FIG. 1, the fuel cell 100 includes a plurality of stacked cells 10, and a pair of current collector plates 11, a pair of insulator plates 12, and a pair of end plates 13 which are respectively disposed on both sides in a stacking direction of the cells 10. In addition, the fuel cell 100 includes a gas tube 14 that is formed in at least one of the end plates 13. The gas tube 14 communicates with a manifold (not illustrated).

The cells 10, and the current collector plate 11, the insulator plate 12, and the end plate 13 on the gas tube 14 side are provided with four through-holes P1 to P4 which communicate with the gas tube 14 and pass through the members in the stacking direction of the cells 10. A fuel gas is supplied and discharged through the through-holes P1 to P4.

The fuel cell 100 is provided with a sealing material 15 between respective members such as the current collector plate 11, the insulator plate 12, the end plate 13, and the gas tube 14. For example, the sealing material 15 is an O-ring that surrounds an outer side of the through-holes P1 to P4, and contains an elastomer material. When the sealing material 15 comes into contact with respective members adjacent to each other to seal an outer periphery of the through-holes P1 to P4, gas leakage from the through-holes P1 to P4 can be suppressed.

The pair of end plates 13 are fastened by fastening members such as a bolt and a nut, and a fastening force is applied to the fuel cell 100 in the stacking direction of the respective members of the fuel cell 100 which are sandwiched between the end plates 13. Due to the fastening force, the stacked structure of the respective members between the end plates 13 is fixed, and the fuel gas is sealed inside the fuel cell 100.

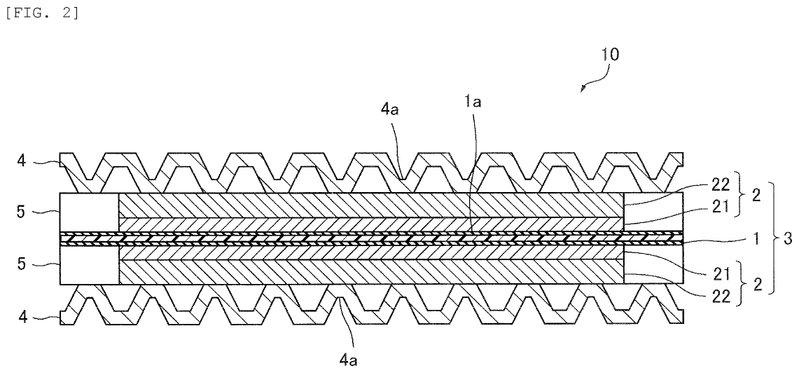

FIG. 2 illustrates the configuration of a cell 10.

The cell 10 includes a membrane electrode assembly (MEA) 3, a pair of separators 4 which are respectively disposed on both sides of the MEA 3, and a sub-gasket 5 that surrounds an outer periphery of the MEA 3. The MEA 3 includes an electrolyte membrane 1 and a pair of electrodes 2. The pair of electrodes 2 sandwich the electrolyte membrane 1.

The electrolyte membrane 1 is an ion conductive polymer electrolyte membrane. Examples of a polymer electrolyte that can be used in the electrolyte membrane 1 include a perfluorosulfonic acid polymer such as Nafion (registered trademark) and Aquivion (registered trademark); an aromatic polymer such as sulfonated polyether ether ketone (SPEEK) and sulfonated polyimide; an aliphatic polymer such as polyvinyl sulfonic acid and polyvinyl phosphoric acid.

The electrolyte membrane 1 may be a composite membrane in which a porous base material 1a is impregnated with the polymer electrolyte from the viewpoint of improving durability. As the porous base material 1a, a porous membrane, a woven membrane, a non-woven membrane, a fibrillar membrane, and the like can be used without particular limitation as long as the membranes have a void capable of carrying the polymer electrolyte. As a material for the porous base material 1a, the above-described polymer electrolyte can be used from the viewpoint of enhancing ion conductivity without particular limitation. Among these, fluorine-based polymers such as polytetrafluoroethylene, a polytetrafluoroethylene-chlorotrifluoroethylene copolymer, and polychlorotrifluoroethylene are excellent in strength and shape stability.

In the pair of electrodes 2, one electrode 2 is an anode, and is also referred to as a fuel electrode. The other electrode 2 is a cathode, and is also referred to as an air electrode. As the fuel gas, a hydrogen gas is supplied to the anode, and air including an oxygen gas is supplied to the cathode.

In the anode, a reaction in which electrons (e) and protons (W) are generated from the hydrogen gas (H₂) occurs. The electrons migrate to the cathode through an external circuit (not illustrated). Due to the migration of the electrons, a current is generated in the external circuit. The protons migrate to the cathode through the electrolyte membrane 1.

In the cathode, due to the electrons migrated from the external circuit, oxygen ions (O₂⁻) are generated from the oxygen gas (O₂). The oxygen ions are bonded with the protons (2H⁺) migrated from the electrolyte membrane 1 into water (H₂O).

Each of the electrodes 2 includes a catalyst layer 21. The electrode 2 in this embodiment includes a gas diffusion layer 22 for improvement in diffusibility of the fuel gas. The gas diffusion layer 22 is disposed on a separator 4 side of the catalyst layer 21.

The catalyst layer 21 promotes a reaction between the hydrogen gas and the oxygen gas due to a catalyst. The catalyst layer 21 contains a catalyst, a carrier that carries the catalyst, and an ionomer that covers the catalyst and the carrier.

Examples of the catalyst include metals such as platinum (Pt), ruthenium (Ru), iridium (Ir), rhodium (Rh), palladium (Pd), and tungsten (W), mixtures and alloys of these metals, and the like. Among these, platinum, a mixture and an alloy which contain platinum, and the like are preferable from the viewpoint of catalytic activity, poisoning resistance to carbon monoxide, heat resistance, and the like.

Examples of the carrier include conductive porous metal compounds such as mesoporous carbon and Pt black which have pores. The mesoporous carbon is preferable from the viewpoint of satisfactory dispersibility, a large surface area, and less grain growth at a high temperature even when the amount of catalyst carried is large.

As the ionomer, the same ion conductive polymer electrolyte as in the electrolyte membrane 1 can be used.

The gas diffusion layer 22 can uniformly diffuse the fuel gas supplied to the cell 10 on the entire surface of the catalyst layer 21.

The gas diffusion layer 22 can be formed by disposing a gas diffusion layer sheet as an outermost layer of the MEA 3. Examples of the gas diffusion layer sheet include a porous fiber sheet such as carbon fiber having conductivity, gas permeability, and gas diffusivity, and a metal sheet material such as a foamed metal and an expanded metal.

The sub-gasket 5 is a film or a plate that surrounds an outer peripheral edge of the MEA 3, and functions as a support for the MEA 3. As a material for the sub-gasket 5, a resin with low conductivity can be used. The resin material is not particularly limited, and examples thereof include polyphenylene sulfide (PPS), glass-filled polypropylene (PP-G), polystyrene (PS), a silicone resin, a fluorine-based resin, and the like.

### (Separator)

The separator 4 is also referred to as bipolar plate. A plurality of concave portions 4a, which communicate with the through-holes P1 to P4, are formed in a surface of the separator 4. When the surface of the separator 4 in which the concave portion 4a is formed faces the MEA 3, a fluid flow passage is provided between the separator 4 and the MEA 3. The flow passage is not only a supply path of the fuel gas but also a discharge path of water generated by a chemical reaction in power generation. In a case where cooling water is used for cooling of the fuel cell 100, the flow passage is also used as a path for the cooling water.

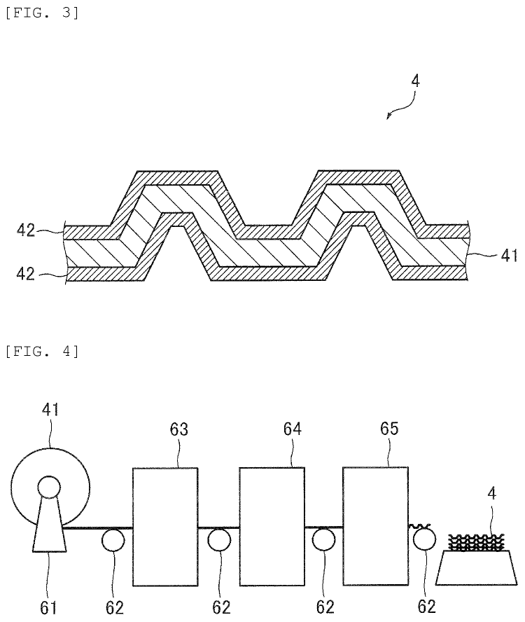

FIG. 3 is an enlarged cross-sectional view illustrating a layer structure of the separator 4.

As illustrated in FIG. 3, the separator 4 includes a conductive substrate 41 and a protective layer 42.

In the first embodiment, the substrate 41 is formed from a conductive material, for example, stainless steel, titanium, aluminum, copper, nickel, steel, or the like.

The substrate 41 may be provided with a plated layer formed on a surface through a metal plating treatment from the viewpoint of corrosion resistance and adhesiveness with the protective layer 42. Examples of the metal plating include tin plating, nickel plating, multi-layer plating thereof, alloyed plating, and the like. In addition, the substrate 41 may be provided with an etching layer, a polishing layer, or the like formed on the surface by a phosphate treatment or the like from the viewpoint of adhesiveness to the protective layer 42.

The thickness of the substrate 41 is not particularly limited, but can be set to 0.05 to 0.5 mm from the viewpoint of compatibility between a molding property and reduction in weight.

### (Protective Layer)

The protective layer 42 is provided to a surface of the substrate 41, suppresses oxidation of the surface, and enhances corrosion resistance of the substrate 41. In addition, the protective layer 42 prevents defects such as cracking in the substrate 41, and can reduce leakage of the fuel gas to the outside.

### (Self-Restoring Material)

The protective layer 42 contains a self-restoring material. A self-restoring property represents a function of recombining and restoring a cut site even in a case where a formed body such as the protective layer 42 containing the self-restoring material is damaged. For example, the recombination may be a covalent bond, a hydrogen bond, an ionic bond, or a coordinate bond, or a bond due to an electrostatic interaction, a hydrophobic interaction, a 7c-electron interaction, or an inter-molecular interaction other than these interactions.

The separator 4 is manufactured by processing forming such as press processing for forming the concave portions 4a and hole processing for forming the through-holes P1 to P4, but there is a concern that defects such as a pin hole, a void, and a crack may occur in the protective layer 42 due to a compressive stress to the substrate 41, an operation of a local tensile stress according to plastic deformation, or the like at the time of processing forming. In addition, defects such as a crack and a void may occur inside of the substrate 41 or on a surface thereof due to the processing forming.

As described above, even in a case where defects occur at the time of manufacturing or after manufacturing, parts of the self-restoring materials in the protective layer 42 are recombined and a defective portion is restored, and thus the corrosion resistance of the separator 4 and the sealing property for the fuel gas can be maintained for a long time, and reliability of the fuel cell 100 is improved.

Since the defects derived from the processing forming can be restored, it is not necessary to avoid occurrence of defects due to the processing forming by forming the protective layer 42 after the processing forming, and formation of the protective layer 42 may be carried out either before or after the forming processing, and thus the degree of freedom in a manufacturing process is improved. In a case where the processing forming is carried out after forming the protective layer 42, a roll-to-roll method with high production efficiency can be employed.

In addition, according to the self-restoring material, a heating treatment of melting a resin component in the protective layer 42, which is carried out to restore detects occurred due to the processing forming, is not necessary. Accordingly, a heat treatment process can be reduced, and manufacturing cost can be reduced.

Examples of the self-restoring material include an organic material such as a polymer, and an inorganic material such as ceramic and a metal, and known materials can be used. Examples of known organic materials include a multi-block copolymer that includes a hard segment formed from a hard polymer having a glass transition temperature of 150° C. or higher and a soft segment formed from a soft polymer having a glass transition temperature of −30° C. or lower and has a certain amount of disulfide bonds (refer to JP-A-2018-39876), a polymer material containing a cross-linked polymer that is cross-linked by an interaction between a host group and a guest group (refer to International Publication No. 2017/159346), and a copolymer of ethylene and anisylpropylenes which uses a scandium catalyst (refer to “Synthesis of Self-Healing Polymers by Scandium-Catalyzed Copolymerization of Ethylene and Anisylpropylenes”, Haobing Wang, five others, J. Am. Chem. Soc., American Chemical Society, 2019, 141, p. 3249 to 3257), but there is no limitation to the materials.

in addition, examples of known inorganic materials include a metal titanium dispersed alumina ceramic-based composite material (refer to Electrochemically Assisted Room-Temperature Crack Healing of Ceramic-Based Composites, Shengfang Shi, Tomoyo Goto, Sung Hun Cho, Tohru Sekino, J. Am. Ceram. Soc., Journal of the American Ceramic Society (Jan. 9, 2019 online), https://doi.org/10.1111/jace.16264), and the like, but there is no limitation thereto.

Among the materials, it is preferable that the self-restoring material is a material having the self-restoring property even in a case where water molecules exist and an operation for self-restoring is not input from an outer side.

The separator 4 for the fuel cell 100 is placed under an environment in which a hydrogen gas is supplied in power generation, and water is generated, but according to the above-described self-restoring material, self-restoring is possible even under the environment. In addition, even in a case where an operation other than the operation by the fuel cell 100, for example, an operation of applying energy such as irradiation with infrared rays, ultraviolet rays, or the like, heating, or pressurization is not input from the outside of the fuel cell 100, in the case of the self-restoring material, it is not necessary to apply the operation for self-restoring to the separator 4 that is disposed inside the fuel cell 100. Accordingly, it is possible to omit a device or work for applying an operation from the outside of the fuel cell 100 separately from the fuel cell 100.

In addition, in the self-restoring material, it is preferable that parts of the self-restoring material are combined due to contact with each other and are restored. As described above, since the fuel cell 100 is fastened in the stacking direction of respective members of the fuel cell 100 with the fastening members, the separator 4 is also fastened in the stacking direction. Accordingly, the protective layer 42 is likely to be crushed by members with the separator 4 interposed therebetween due to shaking of a vehicle during traveling, thermal expansion or wet expansion of the electrolyte membrane 1 during power generation, or the like. The crushed protective layer 42 spreads in an in-plane direction, and thus contact between parts of the self-restoring materials in the protective layer 42 is likely to occur, and even in a case where an operation from the outside of the fuel cell 100 is not input, spontaneous self-restoring becomes easy.

Note that, the fastening members which fasten the protective layer 42 may be a fixing member that fixes a stack of the cell 10, and a fastening direction may be an in-plane direction of the cell 10 instead of the stacking direction. In addition, a fastening force for promoting contact of the self-restoring material may be applied to the protective layer 42 by a fastening member that is provided separately from the fastening members for fixing respective members of the fuel cell 100.

Examples of the self-restoring material that combines due to contact even in a case where water molecules exist and an operation from the outside is not input include the copolymer of ethylene and anisylpropylene. It was found that the copolymer of ethylene and anisylpropylene exhibits the same self-restoring property as under a dry condition even in water or in the presence of 1 M of NaOH or 1 M of HCl. In addition, it was found that the self-restoring of the copolymer of ethylene and anisylpropylene occurs spontaneously by contact between cut sites without necessity for the external operation such as irradiation with ultraviolet rays.

The protective layer 42 of this embodiment is provided to both surfaces of the substrate 41 and covers the entire surface, but the protective layer 42 may be provided to at least a part of the surface of the substrate 41.

Particularly, it is preferable that the protective layer 42 is provided to at least a part of the concave portion 4a. Defects are likely to occur in the concave portion 4a, and thus defect restoring by the self-restoring material in the protective layer 42 greatly contributes to maintenance of the corrosion resistance of the separator 4 and the sealing property for the fuel gas.

### (Conductive Filler)

It is preferable that the protective layer 42 further contains a conductive filler. It is possible to suppress deterioration in the conductivity of the separator 4 due to the conductive filler.

Examples of the conductive filler include carbon, metal carbide, metal oxide, metal nitride, metal fiber, a metal powder, and the like.

Examples of carbon include graphite, carbon black, carbon fiber, carbon nanofiber, a carbon nanotube, and the like. Examples of the metal carbide include tungsten carbide, silicon carbide, calcium carbide, zirconium carbide, tantalum carbide, titanium carbide, niobium carbide, molybdenum carbide, and the like.

Examples of the metal oxide include titanium oxide, ruthenium oxide, indium oxide, and the like. Examples of the metal nitride include chromium nitride, aluminum nitride, molybdenum nitride, zirconium nitride, tantalum nitride, titanium nitride, gallium nitride, niobium nitride, vanadium nitride, boron nitride, and the like. Examples of the metal fiber include iron fiber, copper fiber, stainless steel fiber, and the like. Examples of the metal powder include a nickel powder, a tin powder, a tantalum powder, a niobium powder, and the like.

Among the above conductive fillers, carbon is excellent in conductivity and corrosion resistance, and thus carbon is preferable.

The amount of conductive filler contained in the protective layer 42 may be set to 5% by volume to 99% by volume. In this range, conductivity and formability are likely to be satisfactory.

The thickness of the protective layer 42 is preferably 10 to 200 μm. In this range, sufficient corrosion resistance is likely to be obtained, and the fuel cell 100 is easily made compact.

### (Method for Manufacturing Separator)

A method for manufacturing the separator 4 includes a step of forming the protective layer 42 on at least a part of the surface of the substrate 41, and a step of performing forming processing on the substrate 41 on which the protective layer 42 is formed. Examples of the forming processing include press processing, hole processing, cutting processing, and the like.

The procedure of the respective steps is not particularly limited, but in the case of performing the processing forming after forming the protective layer 42, manufacturing by the roll-to-roll method is possible and production efficiency is high. Accordingly, this case is preferable. As described above, in a case where the protective layer 42 is previously formed, defects are more likely to occur in the protective layer 42 in comparison to a case where the processing forming is previously performed. However, these defects are restored by the self-restoring material, and thus the corrosion resistance of the separator 4 and the sealing property for the fuel gas can be maintained for a long time.

FIG. 4 illustrates a process of manufacturing the separator 4 by the roll-to-roll method.

As illustrated in FIG. 4, a roll of the substrate 41 is unwound by an unwinder 61 and is conveyed by a roller 62. The conveyed substrate 41 is subjected to a pretreatment such as washing and drying in a pretreatment device 63.

The substrate 41 after the pretreatment is conveyed to a coating device 64. In the coating device 64, an ink for forming the protective layer 42, which contains the self-restoring material and the conductive filler, is coated on the substrate 41 and is dried, thereby forming the protective layer 42. The ink may contain a solvent, a dispersant, or the like as necessary.

The substrate 41 on which the protective layer 42 is formed is conveyed to a processing device 65, and is forming-processed in the processing device 65. For example, the substrate 41 is press processed, and the concave portion 4a is formed in the surface of the substrate 41. In addition, the substrate 41 is hole processed, and the through-holes P1 to P4 are provided. Finally, the substrate 41 is cut into a predetermined size, and the separator 4 is manufactured.

According to the roll-to-roll method, continuous production becomes possible, and thus production efficiency is high, and an area for forming the protective layer 42 can be easily increased.

Note that, the all processes in FIG. 4 are described as continuous processes, but there is no limitation thereto. For example, the processes may be divided into a process of winding the substrate 41 on which the protective layer 42 is formed, and a process of performing the processing forming by successive conveyance in which the wound substrate 41 is unwound and is conveyed with constant intervals.

### (Method for Manufacturing Fuel Cell)

The fuel cell 100 is manufactured by disposing the pair of separators 4 on both sides of the MEA 3. For example, the MEA 3 is obtained by coating both sides of the electrolyte membrane 1 with an ink containing a material for the catalyst layer 21 and drying the ink, and by stacking the gas diffusion layer sheet on the catalyst layer 21 to form the gas diffusion layer 22.

As described above, the fuel cell 100 according to the first embodiment includes the separator 4 in which the protective layer 42 containing the self-restoring material is provided to at least a part of the surface of the substrate 41. Even in a case where defects occur in the protective layer 42, the defects are restored, and thus it is possible to provide the separator 4 in which defects of the protective layer 42 are less not only at the time of manufacturing but also after the manufacturing, and which is excellent in the corrosion resistance and the sealing property for the fuel gas. In addition, a process such as a heating treatment for restoring the defects in the protective layer 42 is not necessary, and the separator 4 can be manufactured by not only a batch method but also the roll-to-roll method, and thus production efficiency of the separator 4 can be enhanced.

### Second Embodiment

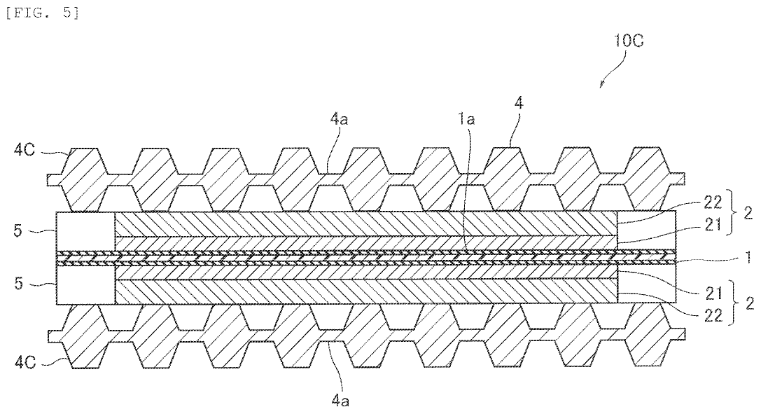

FIG. 5 illustrates a configuration of a cell 10C in a fuel cell according to a second embodiment.

The cell 10C includes a conductive carbon separator 4C instead of the separator 4 according to the first embodiment. The configuration of the cell 10C is the same as in the cell 10 according to the first embodiment except for the separator 4C. The same reference numeral will be given to the same configuration, and detailed description thereof will be omitted.

As in the metal separator 4, a concave portion 4a is formed in the surface of the carbon separator 4C. The carbon separator 4C can be manufactured by mold molding.

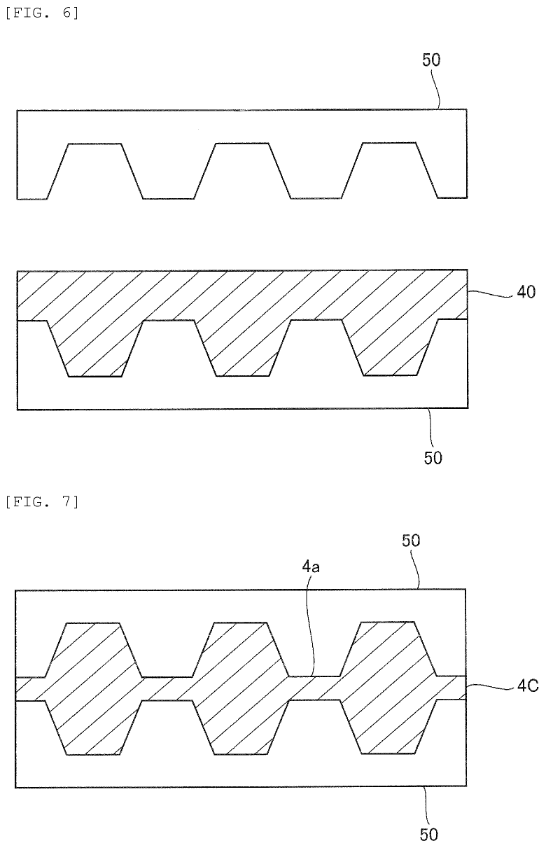

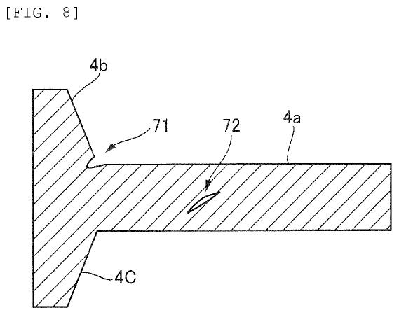

FIG. 6 and FIG. 7 illustrate a process of manufacturing the carbon separator 4C by the mold molding.

First, as illustrated in FIG. 6, a separator material 40 flows into a lower mold 50. The separator material 40 is a composition containing carbon and a resin. Next, as illustrated in FIG. 7, the separator material 40 is heat pressed by an upper mold 50, and the separator 4C in which a plurality of the concave portions 4a are formed in a surface is manufactured.

Defects may occur on the surface or the inside of the separator 4C that is pressed and heated in the manufacturing process. Particularly, defects are likely to occur in the concave portions 4a of which a thickness varies.

FIG. 8 illustrates an example of the defects occurred in the concave portions 4a.

As illustrated in FIG. 8, a recess 71 called sink marks occurs at a corner of the concave portions 4a. In addition, a crack 72 occurs at the inside. The defects become an initiation point, and the defects may grow due to vibration of a vehicle on which the separator 4C is mounted after manufacturing, a difference pressure in a flow passage, a deviation in a fastening force, or the like.

The carbon separator 4C contains a self-restoring material at the inside thereof. The self-restoring material is the same material as in the metal separator 4, and thus detailed description thereof will be omitted. Even in a case where defects occur at the time of manufacturing or after the manufacturing, in the separator 4C containing the self-restoring material, even though an operation from the outside is not applied, parts of the self-restoring material are recombined and a defective portion is restored. Accordingly, the corrosion resistance of the separator 4C and the sealing property for the fuel gas can be maintained for a long time, and reliability of the fuel cell 100 is improved. Note that, as in the separator 4, a fastening force is applied to the separator 4C. Contact occurs easily due to the fastening force, the self-restoring becomes easy.

The separator 4C containing the self-restoring material at the inside can be obtained by mixing the self-restoring material in the composition of carbon and the resin and by mold molding the resultant mixture. The separator 4C of which a surface is covered by the self-restoring material may also be obtained by coating the surface of the separator 4C after being molded with the self-restoring material.

As described above, according to the second embodiment, the carbon separator 4C contains the self-restoring material at the inside. Even when defects occur in the separator 4C, the defects are restored, and thus it is possible to provide the separator 4C in which defects of the separator 4C are less not only at the time of manufacturing but also after the manufacturing, and which is excellent in the corrosion resistance and the sealing property for the fuel gas.

Hereinbefore, description has been given of preferred embodiments of the invention, but the invention is not limited to the embodiments, and various modifications and changes can be made within the scope of the invention.

### REFERENCE SIGNS LIST

100: Fuel cell
1: Electrolyte membrane
2: Electrode
3: MEA
4: Metal separator
41: Substrate
42: Protective layer
4C: Carbon separator

1. A separator (4) for fuel cells, the separator comprising:
a conductive substrate (41); and
a protective layer (42) that covers at least a part of a surface of the substrate (41),
wherein the protective layer (42) contains a self-restoring material.

2. The separator (4) according to claim 1,
wherein the surface of the substrate (41) has a concave portion (4a), and
the protective layer (42) covers at least a part of the concave portion (4a).

3. A conductive separator (4C) for fuel cells, containing:
a self-restoring material at an inside.

4. A fuel cell (100) including a plurality of membrane electrode assemblies (3), the fuel cell comprising:
a pair of separators (4) which are respectively disposed on both sides of each of the membrane electrode assemblies (3) and in which a surface on the membrane electrode assembly (3) side has a concave portion (4a),
wherein the separators (4) include a conductive substrate (41), and a protective layer (42) that covers at least a part of a surface of the substrate (41), and
the protective layer (42) contains a self-restoring material.

5. A fuel cell (100) including a plurality of membrane electrode assemblies (3), the fuel cell comprising:
a pair of separators (4C) which are respectively disposed on both sides of each of the membrane electrode assemblies (3) and in which a surface on the membrane electrode assembly (3) side has a concave portion (4a),
wherein the separators (4C) contain a self-restoring material at the inside.

6. The fuel cell (100) according to claim 4,
wherein the self-restoring material has a self-restoring property even in a case where water molecules exist and an operation for self-restoring is not input from an outer side.

7. The fuel cell (100) according to claim 4,
wherein parts of the self-restoring material are fastened, are brought into contact with each other, and are combined by members of the fuel cell (100).

8. A method for manufacturing a separator (4) for fuel cells, the separator (4) including a conductive substrate (41) with a protective layer (42) on at least a part of a surface of the substrate (41), the method comprising:
a step of forming the protective layer (42) on at least the part of the surface of the substrate (41); and
a step of performing forming processing on the substrate (41) on which the protective layer (42) is formed,
wherein the protective layer (42) contains a self-restoring material.

9. The method for manufacturing a separator (4) according to claim 8,
wherein a roll of the substrate (41) is unwound and conveyed,
in the step of forming the protective layer (42), the protective layer (42) is formed on the substrate (41) that is conveyed, and
in the step of performing forming processing, the forming processing is performed on the substrate (41) that is conveyed.

10. The fuel cell (100) according to claim 5,
wherein the self-restoring material has a self-restoring property even in a case where water molecules exist and an operation for self-restoring is not input from an outer side.

11. The fuel cell (100) according to claim 5,
wherein parts of the self-restoring material are fastened, are brought into contact with each other, and are combined by members of the fuel cell (100).
